(19) United States
(12) Patent Application Publication
(10) Pub. No.: US 2005/0065893 A1
(43) Pub. Date: Mar. 24, 2005

(54) System and Method for Commingled Remittance Payment Processing

(75) Inventor: Stanley M. Josephson, Dallas, TX (US)

Correspondence Address: SEYFARTH SHAW, 55 EAST MONROE STREET, SUITE 4200, CHICAGO, IL, 60603-5803, US

(73) Assignee: THE ALLIANCE GROUP OF TEXAS, Dallas, TX (US)

(21) Appl. No.: 10/605,278

(22) Filed: Sep. 19, 2003

(51) Int. Cl. G06F 17/60

(52) U.S. Cl. 705/64

(57) ABSTRACT

A system and method for processing payment materials having at least one side with payment information, comprising providing a database having at least one electronic template having biller information specific to a biller, scanning the side of the payment materials to create a digital image, parsing the digital image for the payment information; and matching the payment information with the biller information.

### BACKGROUND OF INVENTION

The present invention relates generally to systems and methods for processing payment documents and, more specifically, to data processing that allows bill payment documents to be processed in a commingled manner negating the need to sort the bill payments by biller prior to commencement of processing and acceptance.

Currently bill payment statements or invoices that are mailed by billers every month have respective and differing bill printing, collection and remittance processes. Billing statements and payment coupons vary from postal card size documents printed with dot matrix printers to full-page 8½″ by 11″ laser printed statements. Most have a tear-off return portion that contains at least the consumer's accounts receivable number and payment due amount. However, these data fields are printed on the document in different positions, formats and fonts for each of the different billers.

While not standardized, most biller's have positioned the accounts receivable number and payment due amount in Optical Character Recognition (OCR) machine-readable font. However, this information may also be printed anywhere on the return portion of the document. Because of this lack of standardization and limitations of remittance equipment used for processing the documents, it is necessary to first manually sort all of the documents by biller and then arrange them in proper physical orientation prior to processing. Document sorting and segregation by biller throughout the complete workflow is very important to the accuracy and integrity of remittance processing.

Utilities, telephone, cable, credit card and similar high volume billers often utilize third party service companies or commercial banks to handle their remittance processing functions, often referred to as lockbox services. They routinely receive thousands of payment envelopes on a daily basis. Each household typically makes six to eight recurring payments per month. Although some reduction in remittance volume has recently occurred due to consumer's acceptance of pre-authorized direct debit payments, Internet-based home banking electronic bill payment and presentment (EBPP), and other interactive Web-based electronic bill payment initiatives, the volume of the traditional paper-based process is expected to continue to grow, albeit at a slower rate than in past years.

Typically, a consumer's mailed payment envelope contains payment materials consisting of two documents—a monetary document in the form of a bank check, money order or other negotiable paper, and a supporting accounts receivable document in the form of a bill stub or payment coupon, which may be provided by tear-off return portion discussed above. By initially sorting the envelopes in the incoming mail stream by biller prior to mail opening, more efficient and accurate downstream processing of the consumer's bill payments can be achieved. This sorting is accomplished using one of several methods. The most common is by the assignment of unique Post Office Box number printed on the bill stub or payment coupon using a Post Office assigned barcode. The barcode, visible through the window envelope, is read by high-speed, multi-pocket, reader/sorter machines either at the Post Office or the processing site. The envelope is directed to one of the machine's pockets that is designated for that specific box number. Other sorting methods include manual sorting or key driven sorting devices. Regardless of the method employed, some type of machine-readable and/or human-readable means segregates the envelopes by biller. Some very large service companies may be assigned a unique Post Office ZIP code that allows biller segregation by use of the ZIP plus four configurations.

After the segregation process is completed, the envelopes are opened and the contents inspected, using either manual or automated equipment. The contents, the monetary document and the supporting accounts receivable document are inspected, properly aligned and then placed in batches of documents for the same biller. The batches may then be assigned to a remittance terminal operator. The operator initiates the automated remittance process by first manually adjusting the terminal's reading device to process the biller's batch of work. The accounts receivable document's machine-readable data is read, validated, endorsed, microfilmed or imaged, and pocketed. The document that follows is the monetary document. Its machine-readable data is then read, validated, endorsed, hand-written payment amount read or key entered, microfilmed or imaged, amount encoded and pocketed. During this process, various edits are performed by software that has been specifically tailored to meet the biller's processing requirements.

Some edits that are performed include deciphering the contents and characteristics of the Optical Character Recognition (OCR) line, which generally contains the account number assigned to the consumer, the amount due, due date, and a check digit. Other edits performed, for example, may determine if a full payment is required or if a partial payment is acceptable, acceptance of a late payment without the inclusion of the late fee, tolerance limits for high and low payment amounts, and whether a minimum payment amount is required. Because each biller's requirements vary, the remittance software must be customized to meet those requirements.

Upon completion of the reading, validation, and pocketing processes, an electronic record of the document's extracted machine-readable information is generated. Further, these electronic records create files that are subsequently extracted, formatted and transmitted to the biller to be used to update the biller's accounts receivable accounting records. The physical documents (e.g., the monetary document and the accounts receivable document) are directed to separate pockets of the remittance processing device. The accounts receivable documents are usually stored for an interim period or returned to the biller. The monetary documents are prepared for deposit and delivered to the biller's depository bank to credit the biller's account. The monetary documents then enter the bank's conventional check clearing system and ultimately debit the consumer's bank account at the consumer's bank.

FIGS. 1A-1C illustrates three examples of typical existing remittance documents that show the wide diversity of designs, formats and types of payment materials currently used by billers. The lack of document standardization is readily apparent by examining the contents of the machine-readable Optical Character Recognition (OCR) field. In FIG. 1A the consumer's accounts receivable number 102 is comprised of thirteen (13) digits, in FIG. 1B, the consumer's accounts receivable number 104 is comprised of ten (10) digits, and in FIG. 1C, the consumer's accounts receivable number 106 is comprised of sixteen (16) digits. The OCR field also includes the payment due amount 108, 110, and 112 of nine (9) digits, ten (10) digits, and seven (7) digits respectively. The human-readable fields 114, 116, 118, 120, 122 and 124 depict different placement of the consumer's accounts receivable numbers and payment amount due fields, respectively.

Referring now to FIG. 2, which is a schematic step-by-step, flow chart illustrating existing remittance processing operations 200. Incoming mail is received at the remittance processing site 202. Envelopes are next sorted by biller by manual or automated means 204. Envelopes are then opened by manual or automated means, retaining prior biller sequence 206. Contents of opened envelopes are extracted while retaining prior biller sequence 208. Contents are inspected to determine if payment materials (bill stub or coupon and check or money order) are processable or unprocessable 210. Processable payment materials are placed in batches of 250 to 300 documents while retaining the prior biller sequence 212. Exception processing procedures 214 for unprocessable payment materials which include, for example, missing check, multiple checks, cash payment, irregular payment amount, missing bill stub or coupon, multiple bill stubs or coupons, etc. Next, identification and selection of consumer correspondence, address changes and other consumer requested changes are directed to clerical procedures 216. Examination of monetary documents for negotiability and acceptability 218 that includes, for example, missing or incorrect payee, missing date, post date, stale date, legal and courtesy amount differs, foreign checks, third party checks, restrictive notations, etc. Perform exception processing procedures for non-negotiable checks 220. Generate batch control totals while continuing to retain biller sequence 222. Perform remittance processing automated procedures 224 by biller which includes, for example, adjustment and orientation of terminal reading devices, reading the OCR information from the bill stub or payment coupon, validating the OCR information, parsing and extracting the accounts receivable number and payment due amount, performing the check digit calculations, endorsing the document with an audit trail, microfilming the document, extracting and storing the data in temporary storage media, and pocketing the document 226. Perform validation of the monetary documents by biller, which includes reading the magnetic ink character recognition (MICR) code line information on the bottom of the document, validating the information, keying the payment amount, encoding the document with payment amount, endorsing the document, microfilming the document, extracting and storing the data in temporary storage media, and pocketing the document 228. Balancing the monetary documents to previously generated control totals 230. Preparing monetary documents for deposit 232 and delivery to biller's depository bank 234. Extraction of accounts receivable electronic files, reformatting and transmitting to each biller 236. As can be seen, the existing process is complex and ultimately time consuming.

The remittance processing description above is typical, however, it is very general and it should be appreciated that there are many variations of the process depending on the equipment utilized, software functionality and the biller's requirements.

Regardless of the method employed for remittance processing, segregation of the envelopes and the payment documents for each biller remains a necessary requirement. This segregation of the incoming payment envelopes is a costly, time consuming and error-prone operation. It is necessary, however, due to the lack of format standardization of accounts receivable documents and the functional limitations of remittance terminal devices currently on the market. As a consequence, each biller's work must be processed separately.

### SUMMARY OF INVENTION

The present invention addresses the deficiencies prevalent in existing remittance processing systems wherein the sorting and physically orienting incoming payment materials by biller is a requirement. The present invention discloses a system and method for processing of payment materials in a commingled or unsorted manner while still performing respective validation for billers. It is anticipated that this will result in increased productivity, reduced operational and equipment costs, and elimination of labor-intensive, error-prone operations.

In one embodiment of the present invention, a method of processing remittance payment materials in a commingled manner without regard to the biller by generating an electronic template of each biller's accounts receivable document format is disclosed. This template contains the instructions needed to locate unique printed information in machine-readable and/or human-readable fonts or designs. Additional information may be appended to the template that specifies the respective processing requirements that the biller desires.

In another embodiment of the present invention, a method of performing the remittance processing application includes the use of a terminal device having the capability to read and/or digitally scan both sides of the incoming payment materials and determine the matching biller's electronic template. After the biller has been identified, the payment material's required data is located and extracted for validation according to processing requirements specified by the biller.

It is an objective of the present invention to eliminate the requirement that incoming payment materials be segregated by biller prior to processing.

It is another objective of the present invention to improve the productivity and accuracy of remittance processing operations.

It is yet a further objective of the present invention to reduce the costs associated with remittance processing.

It is a further objective to the present invention to reduce the number of box numbers used by the billers.

Further objectives and advantages of the present invention will become apparent from a consideration of the drawings and ensuing descriptions.

### BRIEF DESCRIPTION OF DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 depicts examples of existing payment materials used by typical billers;

FIG. 2 is a schematic flow chart illustrating prior art remittance processing operations;

FIG. 3 is a schematic flow chart illustrating remittance processing operations in accordance with an embodiment of the present invention;

FIG. 4 is a schematic drawing illustrating the remittance processing terminal and peripheral equipment components located at a remittance processing site of an embodiment of the present invention;

FIG. 5 is a schematic flow chart of generating electronic templates of billing payment materials in accordance with an embodiment of the present invention;

FIG. 6 is a schematic flow chart depicting the processing steps performed at the remittance processing site in accordance with an embodiment of the present invention;

FIG. 7 is a schematic flow chart illustrating a method of processing multiple payment materials from a single consumer in accordance with an embodiment of the present invention; and

FIG. 8 is a schematic flow chart illustrating a method of processing consumer's payment materials consisting of accounts receivable documents and monetary documents in accordance with an embodiment of the present invention.

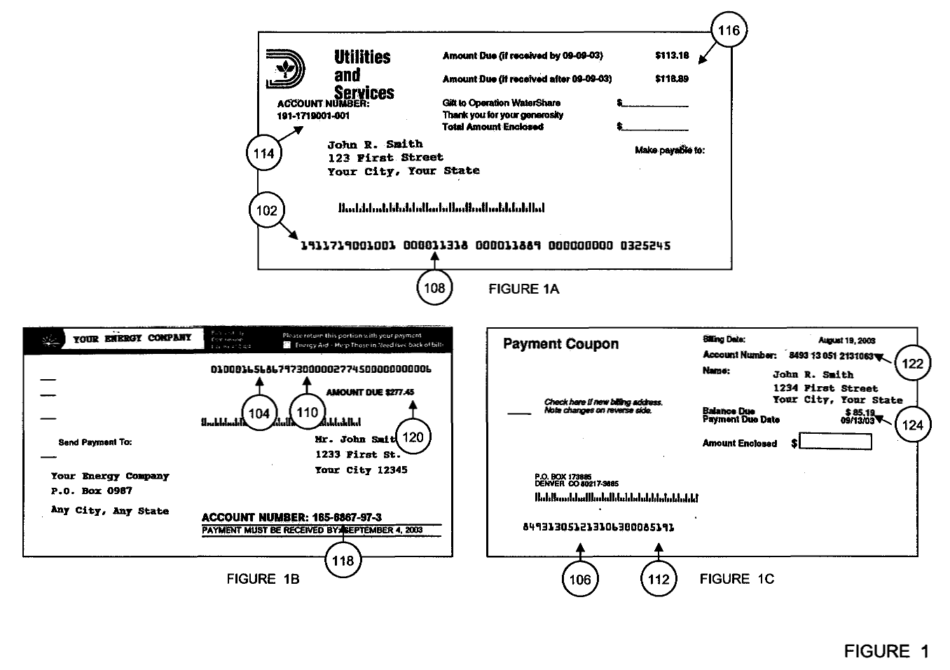

### DETAILED DESCRIPTION

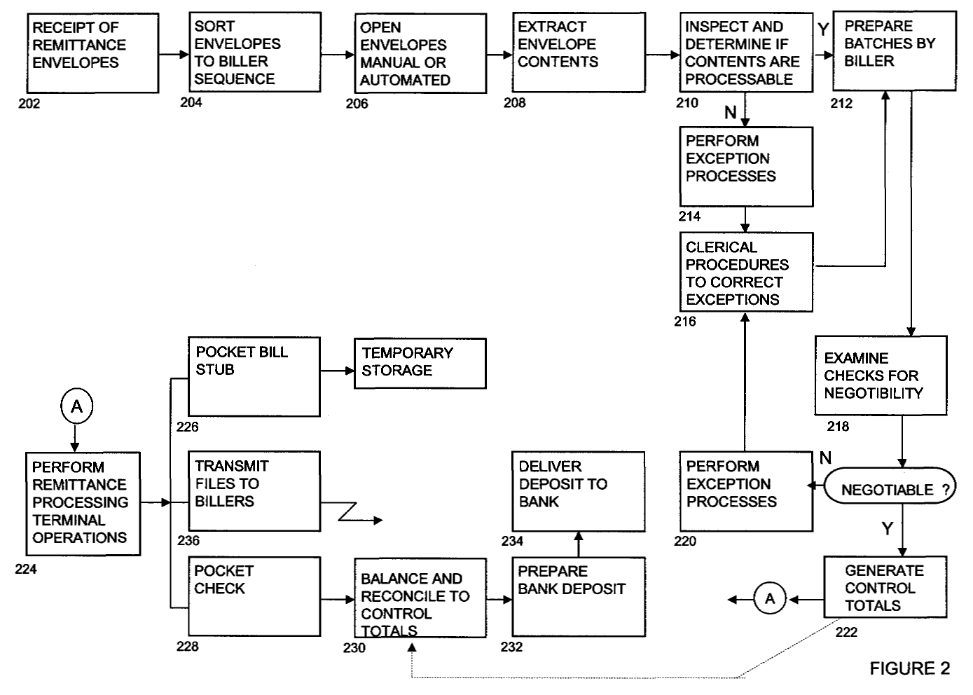

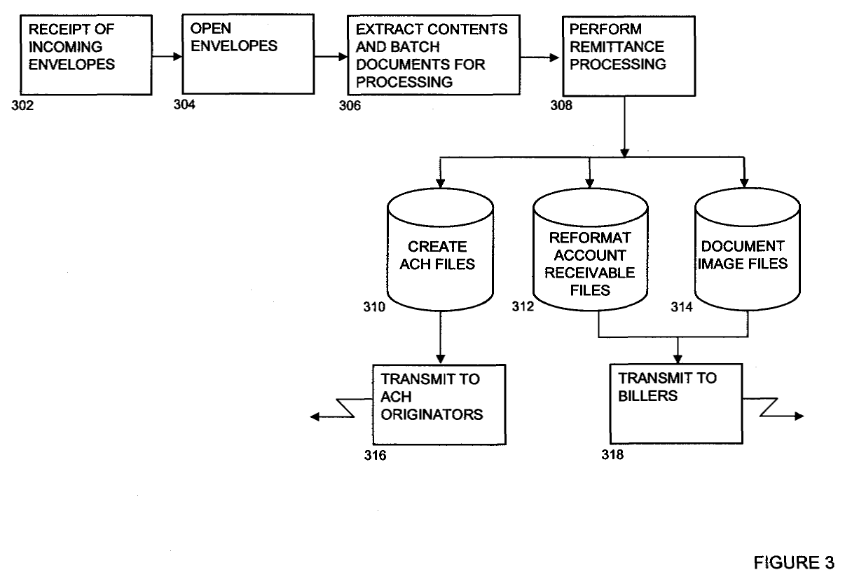

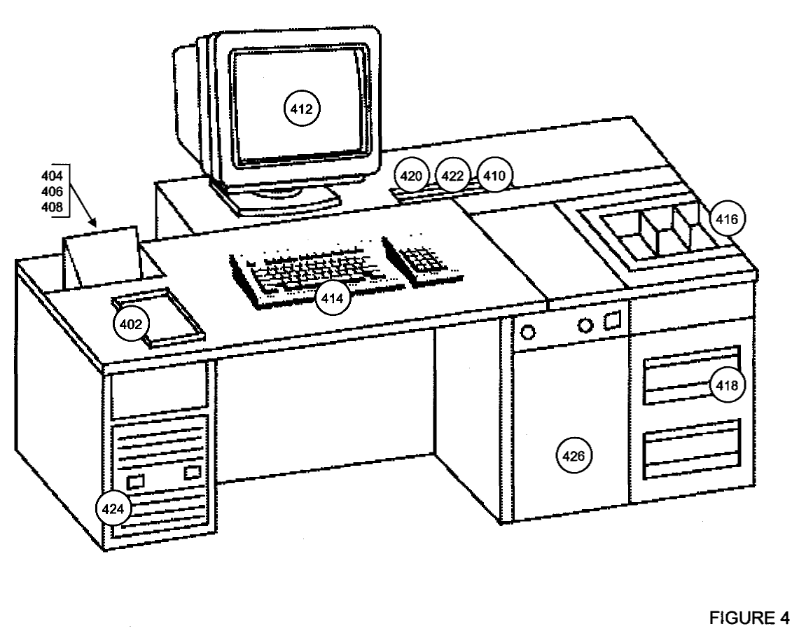

23 FIG. 3 illustrates significant simplification available through the practice of an embodiment of the present invention in comparison to the prior art processing steps described in FIG. 2. In an embodiment, incoming mail is received at the remittance processing site 302. Envelopes are opened by manual or automated means without regard to biller 304. Contents are extracted and the single payment document is placed in batches without regard to biller 306. Remittance processing automated procedures are performed 308 which may include, for example, digitally scanning the payment document to create an image of the document, examining the digital image to retrieve the electronic template corresponding to the biller's document, validating the payment document's OCR information, parsing and extracting the consumer's accounts receivable number and payment due amount, performing check digit calculations, comparing the payment due amount to the consumer's written payment amount, endorsing the payment document with an audit trail, extracting and storing the data in temporary storage media, and pocketing the document. Generating electronic data files from the stored payment data to create Automated Clearing House (ACH) compatible files 310 and reformat account receivable data 312 and payment document images 314. Transmitting ACH files to an ACH originator 316. Transmitting accounts receivable files and document image files to the biller or biller's intermediary processor 318.

Referring to FIG. 4 in an embodiment, a system includes remittance processing terminal devices 400 which, typically, are composed of peripheral components that may include scanning devices 402, OCR 404, barcode 406 and MICR 408 readers, document imaging digital cameras 410, screen display monitors 412, data entry keyboards 414, pocket modules 416, line/page printers 418, encoders 420, endorsers 422, and computer circuitry 424 within the terminals interfaced by cable or communication ports in operable connection with the peripheral components via a controller 424. Computer memory components, modems, data storage devices and the necessary operating systems, databases, Internet connectivity and software needed to execute the application systems may be housed within a personal computer (PC) 426 as an integral component of the remittance terminal. Two or more terminals may be networked and supported by a dedicated server device 428 through a means well known, such as, for example, a communication cable. It should be noted that other types of compatible processing equipment might be included or substituted in the hardware configuration described above.

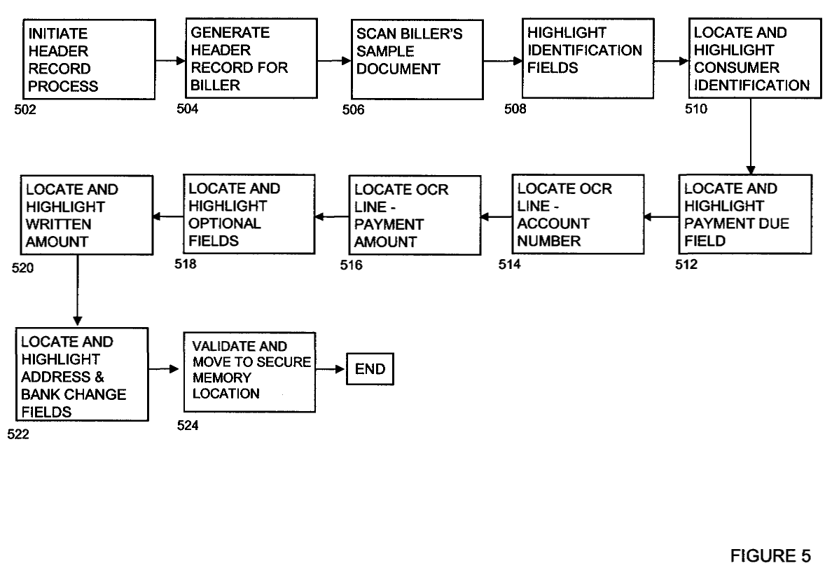

FIG. 5 is a process flow chart representative of an embodiment of the present invention illustrating the steps involved in generating respective electronic templates of biller's payment documents. The payment documents may be in the form of non-negotiable bill stubs or payment coupons. These documents may originate from tear-off portions of repetitive bills such as utility, telephone, cable, credit card, and mortgage and installment coupon books, as discussed previously.

The first step is initiation of program 500, by a terminal operator, which executes the electronic template generation process. The operator then enters the biller's name and an assigned biller identification number and the document's dimensions (length and height). An indicator may also be entered to note that one side of the document will always be blank or will not contain any required or optional fields. The font type used for printing the document, and the data field content and format of the biller's accounts receivable record may also be entered 502. This entry process generates an electronic biller header record 504. A sample of the biller's actual payment document is then scanned (front and back) 506. The operator highlights the unique field(s) and content(s) thereof that will positively identify the document as that used by the biller 508. This may be the return address or box number usually found on the front side of the document and designed to fit into the window of the return envelope that is normally enclosed with the bill, statement or coupon package. However, the address field may only be printed on the backside of the document. By knowing the type and style of return window envelope enclosed by the biller, it is possible to specify the exact placement as to where the address will appear. However, other methods may be used that can search the digitized image for unique codes that are embedded in the United States Postal Service's POSTNET and PLANET bar code fields or, alternatively, to locate the ZIP code and then the return address. Other types of unique identifiers that may be used are the biller's logo, the biller's name and address lines, the biller's telephone number, a watermark, or other printed special symbols or codes.

There are two other required fields to be found on the scanned document. One field is the consumer's identification 510. Most commonly, the consumer's identification will be the accounts receivable account number assigned by the biller and may be machine-readable and embedded in the scan line in an OCR font. Whether located in the scan line or elsewhere, the consumer's identification field is highlighted by the operator and an accompanying menu is displayed that allows the operator to enter the validation rules that include the font style, the number of digits and/or the characters in the field, the position of the check digit, and the check digit validation method 512. Another field in the OCR scan line or found elsewhere on the document may be the payment due amount in dollars and cents 514. This field is also highlighted and a menu may be displayed that requires the operator to enter the number of digits in the field and the maximum and minimum amounts acceptable 516. In addition to the OCR line, the two required fields are usually repeated elsewhere on the document in human-readable font and labeled as account number and payment amount due.

In addition to the two required fields, the biller may specify any number of additional fields 518 that may be needed for validation, payment acceptance or to prepare an accounts receivable record. Some optional fields, for example, may indicate minimum payment amount, the late charge amount, additional payment amounts by type (fees, insurance, additional principal, escrow, etc.), payment amount including late charge, late charge date, closing (cut-off) date, payment or coupon number, current balance amount, previous balance amount, invoice number, reference number, signature line, and Accounts Receivable Conversion System (ARC) truncation indicator. Once again, the operator highlights each of the desired optional fields, enters the validation rules and calculations and appends a label to each.

The biller may also include validation rules. Biller validation rules may include, for example, a minimum acceptable payment amount, the number of days after the due date to require the addition of late fee, the number of grace period days, the rejection of a payment if a minimum payment is not received, the acceptance of a payment that exceeds the amount due, and the rejection of a payment if the consumer indicates that payment is to be made by credit card. The validation rules may also include calculations, for example, the late charge amount plus the payment amount due must equal the amount paid.

Often a document will provide areas reserved for the consumer to write the amount they are paying and any additional amounts that are included in the total payment 520. These fields may also be highlighted and the operator may specify from a menu the acceptable range of minimum and maximum amounts, whether a full payment is required, and whether a minimum payment is required. The consumer may also indicate that a change of address, change of bank, or payment by credit card is requested. The area specified for this type of information is again highlighted and defined as an optional field 522. The electronic template may then be moved into a protected storage area. 524.

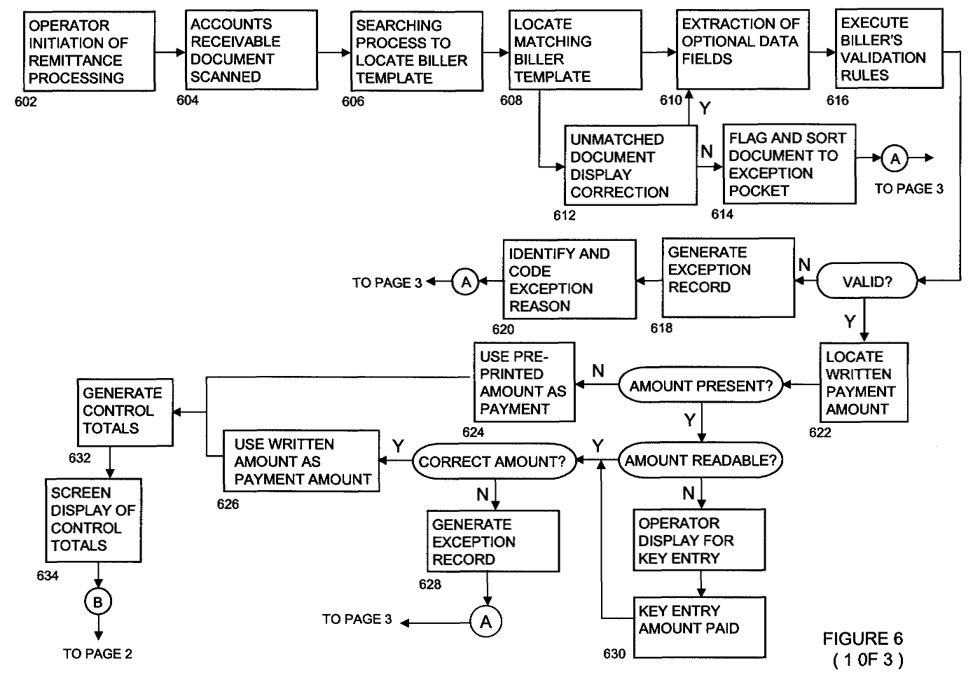

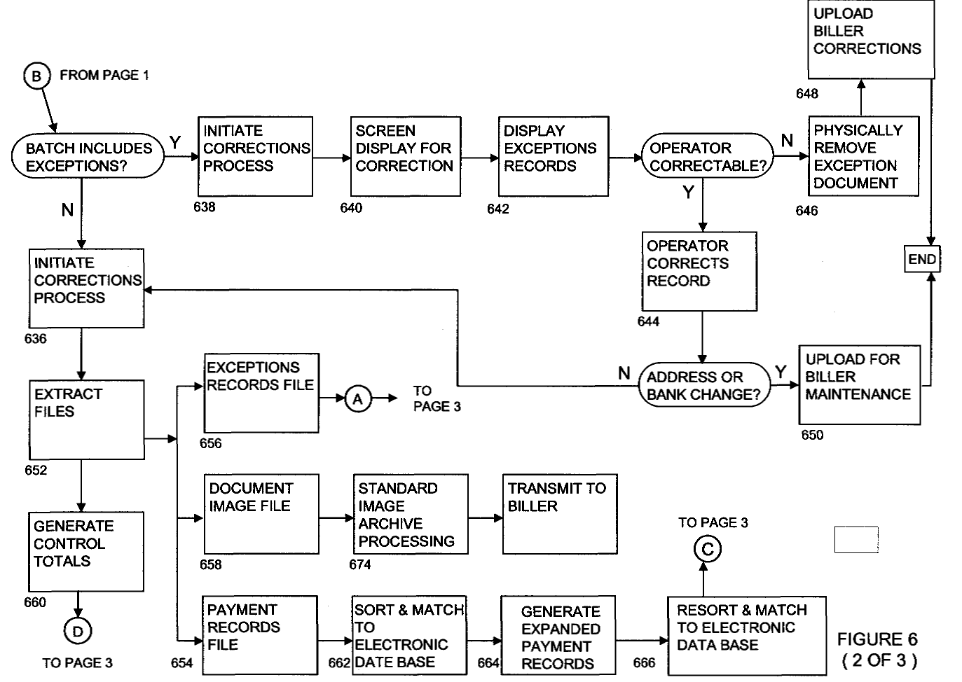

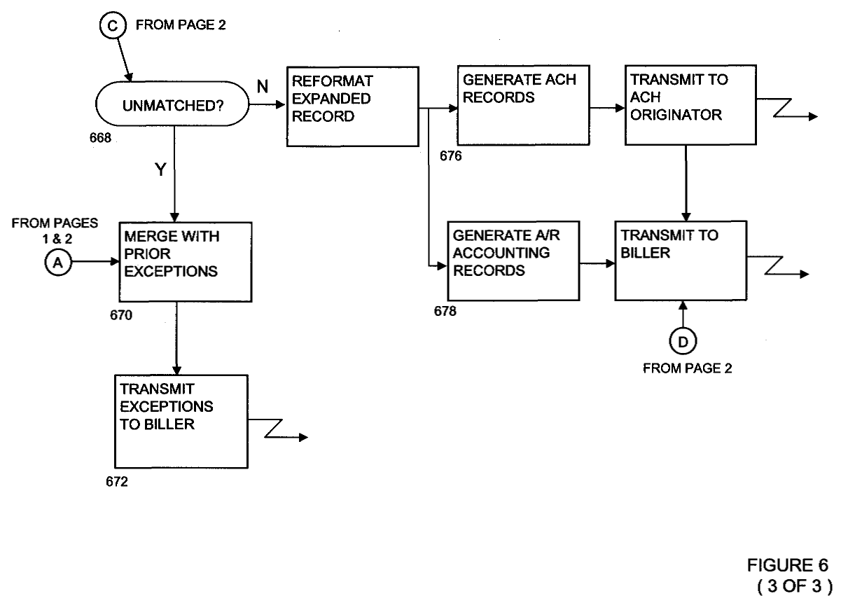

Turning now to FIG. 6, which is a schematic flow chart, representative of an embodiment of the present invention illustrating the processing steps performed at the remittance processing site. In an embodiment of the present invention, an electronic bill payment method is used to process the remittances. This method allows the single, non-negotiable accounts receivable documents to create the electronic financial transactions to cause payment of the bill. Utilizing an electronic database containing the linkage between the consumer's accounts receivable number and the consumer's bank and bank account numbers, the applicable electronic financial transactions are generated that will debit the consumer's checking account, credit the biller's depository account and prepare an electronic accounts receivable record that is used to update the biller's accounts receivable accounting files. This embodiment utilizes the single remittance document process described in U.S. Pat. No. 4,974,878, which is incorporated herein by reference.

The operator initiates the commingled remittance application program, which then, in turn, initiates remittance processing operations 602. In an embodiment, the first accounts receivable document is entered and digitally scanned 604 to create an image of the documents. The digital image of the document (front and back) is parsed and its information matched to the stored electronic templates, searching for the specific template that will match a biller's payment document 606. This may be accomplished, for example, by searching first for the most common window envelope cut-out locations, and when the address field is located, to determine if the Post Office box number agrees with any of the stored template's box numbers. Other methods of locating the matching template, for example, may include searching the image for the biller's logo, biller's name and address, a telephone number, a unique preprinted code, a watermark, etc. When a match is made, the other required field locations are found to ensure that the correct template has been located 608. Other optional fields are found in the same manner i.e., by overlaying the templates highlighted fields to the accounts receivable document 610 and extracting the optional field data.

If a match cannot be made, thus creating an exception condition e.g. a blank document or an unreadable document or an undefined biller's document, the operator is prompted to view the screen image of the document 612. If the operator can manually identify the biller's document by sight, a screen is displayed that will list all billers and their assigned number. The number, when selected, will retrieve the correct template and initiate the validation process. If the operator is unable to positively identify the document, it is flagged and sorted to the reject pocket of the terminal's pocket module 614.

Exception conditions may also be encountered during validation as determined by the biller's validation rules 616. Each exception condition generates an exception record 618. Each type of exception record is assigned an exception code that is appended to the generated accounts receivable record for subsequent reporting, review and correction 620.

The next step in the process is to determine if the preprinted payment due amount agrees with the amount that the consumer has written on the document as the amount they are paying 622. The written amount may be parsed using a well known means, such as, for example, image character recognition (ICR). If there is no written amount present on the document, the pre-printed payment due amount is used 624. The amount may include the late charge amount if the payment date exceeds the late charge due date. If the written amount agrees with the pre-printed amount, subject to the late charge acceptance rules, the payment due amount or payment due amount including late charge is used. If the written amount is less than the payment due amount, the minimum payment rules are used to determine if the payment will be accepted. If accepted, the written amount is used as the payment amount. If not, the document is considered to be an exception and flagged as such. If the written amount exceeds the payment due amount, the fields available for written additional payments, for example, fees, insurance, escrow, and the like, are read and added to determine if the sum is equal to the payment amount. If equal, the written amount is used as the payment amount 626. If unequal, an exception record is generated and flagged as such 628. In all of the above conditions, if any of the written amounts are unreadable, the image is displayed and the operator enters the amount, if discernable 630. If the operator is unable to determine the correct amount or unable to resolve the written amount, the document is also considered as an exception and an exception record generated.

At the end of a batch and at the end of the job, totals are generated for each biller's work processed 632. These totals may include the biller number, the total number of documents processed, the number of exception documents, the total payment amount of accepted documents and overall batch totals and job totals. Totals may be screen displayed and available for screen prints 634.

Batches of documents that do not have any exceptions are available for immediate extraction 636. Batches of documents that have one or more exceptions must enter a correction process 638. The corrections program is then invoked. A screen display of the batch numbers that contain one or more exceptions is provided. The corrections operator selects a batch for correction 640. The image (front and back) of each of the exception documents is displayed along with the exception reason and audit trail number 642. The operator will determine if the exception can be corrected, for example an unreadable amount, a torn, folded or otherwise mutilated document, etc. which may be key entered by the operator. If so, the operator will make the necessary correction and the document will then be accepted 644. If the exception cannot be corrected, the physical document may be physically removed from the batch and deleted from the file, however, the digital image will remain as an audit trail 646. The images of all uncorrected exceptions are uploaded to a server for review by the biller for correction or, alternatively, returned to the consumer 648 for correction and resubmission. Additionally, document images that indicate that the consumer has requested a change of address or a change of bank are electronically made available to the biller via an upload to a server for database maintenance 650. After completion of all batch corrections, batch totals and job totals are regenerated and the file extract program is initiated 636.

Files may be extracted upon completion of all jobs assigned for the processing cycle or at predetermined cutoff intervals 652. Intermediate extracts may occur during the processing cycle in the event of operational problems or when peak volume thresholds are met. The primary files extracted may include, for example, the payment records file 654, the exception records file 656, and the document image file 658. During extracts, totals may be accumulated of the payment dollar amount by biller, the number of records processed by biller, the number of exception records, the number of records processed by operator and overall totals of payment dollar amount, the number of records processed and the number of exception records by biller by exception reason 660. The extracted payment records file may be sorted to the consumer's account receivable number and matched to the electronic payment database 662. The consumer's accounts receivable number is used as a key to obtain the consumer's bank and bank account numbers and other required fields from the electronic payment database that then generates an expanded payment record 664. This expanded payment record file may be resorted to the assigned biller number to extract the biller's depository bank and bank account numbers from the electronic payment database along with other biller fields required for ACH file generation 666. At the completion of this sorting and matching process control, totals may again be collected to rebalance the totals aggregated during the extract.

It will be appreciated that it is possible that during the matching process, that an exception condition occurs which is caused by the payment records accounts receivable number being unmatched to the electronic payment database 668. For example, either the payment document was misread or the consumer was not established as an electronic payment user. In either case, an exception record is generated and merged with the previously extracted exception record file 670. Other exceptions may occur during the process. The file of exceptions may then be transmitted to the biller 672.

The extracted image file utilizes standard image archive systems related procedures to provide both a central image archive access, but also to prepare individual image files for each biller 674.

The expanded payments file is used to generate the ACH file 676. Standard file formats specified for ACH file generation and transmission by NACHA 2003 Operating Guidelines or the equivalent may be used. The ACH Entry Class Code may use the Prearranged Payment and Deposit Entry (PPD) format for all generated electronic transactions. The ACH file may then be transmitted to an ACH originator.

The expanded payments file may also be used to generate a file conforming to the biller's requirements that will update their accounts receivable accounting file to reflect the consumer's payment and prepare related accounting information 678. The file format may be variable and specific to each biller. At a minimum, it will contain the consumer's accounts receivable number, the payment amount and the payment date. The file may then be transmitted to the biller along with the generated control totals.

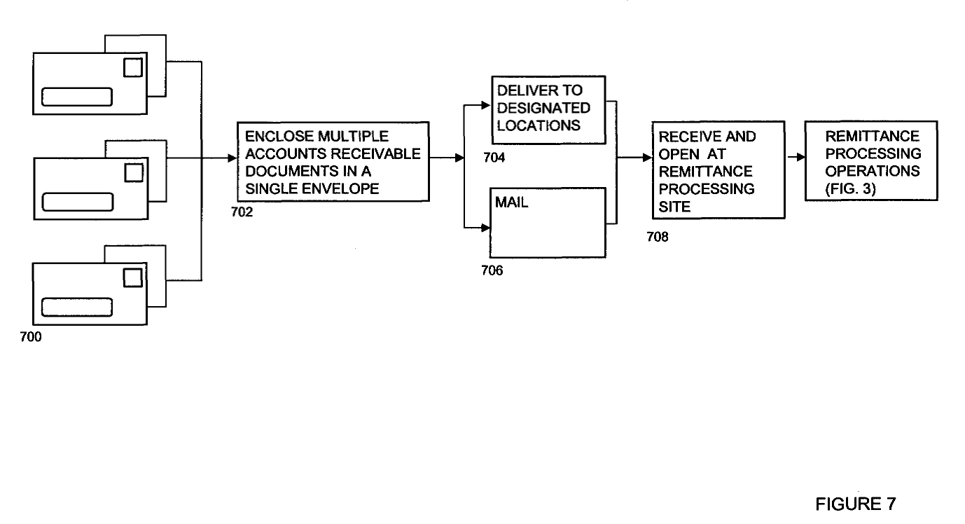

Referring to FIG. 7, which is a schematic flow chart representative of another embodiment of the present invention illustrating a method of processing multiple payment materials from a single consumer 700. In this embodiment, the consumer may choose to include more than one accounts receivable document in a single envelope addressed to the remittance processing site. A pre-addressed envelope would be available for use by the consumer so that payment of multiple bills received by the consumer throughout the month may be paid by enclosing the various accounts receivable documents in the single envelope 702 and dropped off at a predetermined location 704 or mailed 706. When received at the remittance processing site, the operations are the same as previously described in FIG. 3 with the exception that the envelope, when opened, may contain more than one accounts receivable document from the consumer 708 and may also include accounts receivable documents from more than one consumer.

In yet another embodiment, as a means to expedite the consumer's payment of bills, a biller may choose to include a pre-addressed postal card with the bill or statement that is mailed to the consumer. The consumer would then sign and date the card and mail it to the remittance site to initiate bill payment. The postal card may contain sufficient machine-readable bar coded information such as biller identification, the consumer's accounts receivable account number, the payment amount or payment due date to generate the electronic transactions needed to update the accounts receivable files, debit the consumer's bank account and credit the biller's depository bank account when the document is processed at the remittance processing site. The processing operations are the same as in the embodiment previously described in FIG. 3 , with the exception that the envelope opening function is not required.

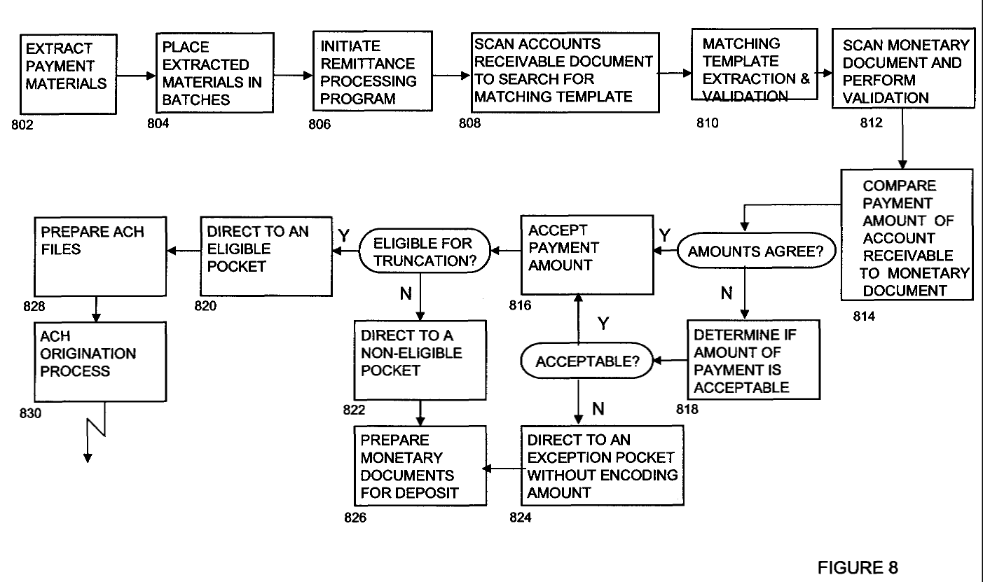

Referring now to FIG. 8, which is a schematic flow chart representative of another embodiment of the present invention that illustrates a method of processing consumer's payment materials utilizing a conventional two-document process. As with the previously described embodiment, an electronic template for each biller will have been generated using the method depicted in FIG. 5 . The mailed envelopes are manually opened or placed in an automated mail opening device without regard to the biller identification or box number. The payment materials are extracted 802. Usually, the payment materials will be composed of two documents, an accounts receivable document and a monetary document such as a negotiable instrument. In some instances, however, there may be a single accounts receivable document supported by two or more monetary documents or conversely, two or more accounts receivable documents offset with a single monetary document.

The extracted payment materials are placed in groups or batches of payments with the accounts receivable document(s) preceding the monetary document(s) 804. These batches are delivered to the remittance terminal operator. The operator places the batch in the read/feed hopper of the terminal device and initiates the remittance processing program 806. The first accounts receivable document is scanned (front and back) and an electronic search is initiated by masking-off highlighted areas of each of the electronic templates to locate matching printed information on the accounts receivable document 808. The rules stored in the matched biller's electronic template are used to then decipher the contents of the OCR scan line to determine the various components of the scan line 810 as described in FIG. 6.

The next document may be the monetary document, its MICR code line is validated and the courtesy amount (the handwritten amount in numerals) is recognized using courtesy amount recognition (CAR) 812, a well known technique. The written amount is compared to the preprinted payment due amount that was extracted from the accounts receivable document 814. Validation of the amount takes into consideration the late charge fees and other amounts that may be applicable as determined by the rules chosen by the biller. If the amounts agree, the payment is accepted 816. If unequal, a partial payment may be accepted, again as determined by the rules chosen by the biller 818. If the monetary document is accepted, the accounts receivable conversion (ARC) truncation indicator, if present, may be examined to determine if the document is eligible for truncation. If eligible, the document may be directed to a pocket of the terminal device designated for truncated documents 820. If not eligible for truncation, the document may be directed to a pocket of the terminal device designated for non-truncated documents 822. If the monetary document was not accepted, an exception record is generated, the monetary document directed to an exception pocket, and the monetary document is not encoded with an amount 824. The next accounts receivable document is read. It may or may not be for the same biller. Regardless, the process described above is repeated. The process continues until all batches have been processed.

As described in FIG. 6 the corrections, extract, file generation and file transmission operations are invoked upon completion of the work or as determined by processing schedules and processing volumes. The physical monetary documents that were not eligible for ARC truncation are either prepared for deposit to a depository bank account or the monetary document images may be transmitted to the depository bank 826 with the physical checks being stored for an interim period and then destroyed. Electronic records created for monetary documents that were eligible for truncation are used to prepare an ACH file 828, which may be transmitted to an ACH originator for, further processing 830.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants” contribution. The actual scope of the protection sought is intended to be defined in the following claims when viewed in their proper perspective based on the prior art.

1. A method of processing payment material, comprising:
providing a database having an electronic template having a biller identifier and a validating record field;
providing on the payment material a biller identification and a payment field;
scanning the payment material to create a digital image;
parsing the digital image for the the biller identification and the payment field;
matching the biller identification with the biller identifier; and
determining if the payment filed matches the input field of the electronic template for the biller.

2. (canceled)

3. The method as claimed in claim 1 wherein the biller identification is selected from a group consisting essentially of a mailing address of the biller, icons, logos, telephone numbers, symbols and watermarks.

4. The method as claimed in claim 1 wherein the biller identification includes machine readable font.

5. The method as claimed in claim 4 wherein the machine readable font includes magnetic ink character recognition font.

6. The method as claimed in claim 4 wherein the machine readable font includes a bar code font.

7. The method as claimed in claim 4 wherein the machine readable font includes an optical character recognizable font.

8. The method as claimed in claim 1 wherein the payment material further includes an accounts receivable conversion truncation indication.

9-21. (canceled)

22. A method of determining if a customer has requested to opt out of truncation of a negotiable document, comprising:
providing on a payment document, that is to be submitted with the negotiable document, an accounts receivable conversion truncation indicator;
scanning the payment document to create a digital image;
parsing the digital image to determine if the accounts receivable conversion truncation indicator is present.

23. A payment document used for submission with a customer's monetary document comprising an accounts receivable conversion truncation indicator to signify the customer's desire of participation in an accounts receivable conversion truncation process.
